(19) United States
(12) Patent Application Publication
(10) Pub. No.: US 2022/0141021 A1
(43) Pub. Date: May 5, 2022

(54) METHODS, SYSTEMS, AND DEVICES FOR CONCEALING ACCOUNT BALANCES IN LEDGERS

(71) Applicant: Tunnel International, Inc., Boston, MA (US)

(72) Inventor: Frank Makrides, Belmont, MA (US)

(21) Appl. No.: 17/574,756

(22) Filed: Jan. 13, 2022

Related U.S. Application Data
(63) Continuation of application No. PCT/US19/59738, filed on Nov. 5, 2019.

(51) Int. Cl. H04L 9/32; H04L 9/08; G06Q 20/40; G06Q 20/38

(52) U.S. Cl. CPC H04L 9/3218; H04L 9/085; G06Q 20/401; H04L 9/0825; H04L 2209/04; H04L 2209/38; G06Q 2220/00; H04L 2209/56; G06Q 20/3829

(57) ABSTRACT

Disclosed herein are methods, systems, and devices for concealing account balances of permissionless distributed ledgers using multi-chain and/or directed acyclic graph (DAG) based structures, while maintaining publicly verifiable transactions. According to one embodiment, a computer-based method for recording a transaction in a ledger having a transacted amount, a first account balance associated with a sender and a second account balance associated with a receiver is disclosed. The computer-based method includes encrypting the transacted amount using a first shared key, decreasing the first account balance by the transacted amount, encrypting the first account balance with a first private key, increasing the second account balance by the transacted amount, encrypting the second account balance with a second private key.

### PRIORITY CLAIM

This application claims priority as a bypass continuation to PCT Patent Application No. PCT/US19/59738, filed Nov. 5, 2019, and entitled “METHODS, SYSTEMS, AND DEVICES FOR CONCEALING ACCOUNT BALANCES IN LEDGERS,” the disclosure of which is incorporated herein by reference in its entirety.

### TECHNICAL FIELD

The present disclosure generally relates to cryptocurrencies and payment systems. More specifically, the disclosure applies to cryptocurrencies and payment systems that store individual accounts and balances in one or more permissionless distributed ledgers using multi-chain or directed acyclic graph (DAG) based structures.

### BACKGROUND

There is a technological problem of cryptographically concealing an account balance in a way that no one can know the balance of the other account but everyone can validate any transaction between any two accounts. This is especially true for decentralized, open and permissionless ledgers where public entities can see data for all accounts within the ledger.

In a traditional blockchain, as commonly used by Bitcoin, a block in the ledger contains multiple transactions between accounts and the ledger also stores the amounts transacted. This is commonly known as unspent transaction outputs (UTXO). A Bitcoin ledger is a single linked chain of blocks. In U.S. Patent Publication No. 2016/0358165, Maxwell describes how the concealing problem is solved for such single blockchain structures that store multiple transactions in one block and tracks UTXO.

However, there are next generation cryptocurrencies, unlike Bitcoin, that do not have a single blockchain, but instead are multi-chain or DAG based. A good example of such cryptocurrencies is Nano Coin® (also known as Raiblocks®) launched in 2015 by Colin LeMahieu. Systems with this type of ledger structure may be highly scalable, unlike single chain Bitcoin, because they may process transactions between two chains in parallel. Some of such systems may also store the total account balance in a block, unlike storing just the transacted amount. These systems do not have adequate solutions to conceal the account balance while staying publicly verifiable.

Accordingly, a need exists for new methods, systems, and devices for concealing account balances of permissionless distributed ledgers using multi-chain and/or directed acyclic graph (DAG) based structures, while maintaining publicly verifiable transactions.

### SUMMARY

Disclosed herein are methods, systems, and devices for solving the technological problem of concealing account balances of permissionless distributed ledgers using multi-chain and/or directed acyclic graph (DAG) based structures, while maintaining publicly verifiable transactions.

According to one embodiment, a computer-based method is disclosed for recording a transaction in a ledger having a transacted amount, a first account balance associated with a sender and a second account balance associated with a receiver. The computer-based method includes (1) encrypting the transacted amount using a first shared key, wherein the first shared key is known to both the sender and the receiver; (2) decreasing the first account balance by the transacted amount; (3) encrypting the first account balance with a first private key, wherein the first private key is known to the sender; (4) increasing the second account balance by the transacted amount; (5) encrypting the second account balance with a second private key, wherein the second private key is known to the receiver; (6) calculating a first next block blinding associated with the first account balance; (7) encrypting the first next block blinding using the first private key; (8) calculating a second next block blinding associated with the second account balance; (9) encrypting the second next block blinding using the second private key; (10) calculating a first new commitment, wherein the first new commitment is a first account new balance representation on an elliptic curve associated with the ledger; (11) calculating a second new commitment, wherein the second new commitment is a second account new balance representation on the elliptic curve associated with the ledger; (12) calculating a first zero knowledge proof indicating the first account balance is greater than or equal to zero; and (13) calculating a second zero knowledge proof indicating the second account balance is greater than or equal to zero. Additionally the ledger is configured for (1) tracking the first account balance and the second account balance within a multi-chain structure, a directed acyclic graph (DAG) based structure, or the like; (2) concealing the first account balance and the second account balance; and (3) allowing public verification of the transaction over a network.

In some embodiments, the computer-based method may further include generating a transaction blinding and encrypting the transaction blinding using a second shared key. The second shared key may be known to both the sender and the receiver. Additionally, the first shared key may equal the second shared key.

In other embodiments, the computer-based method may further include receiving an encrypted transaction blinding. The encrypted transaction blinding may have been generated by a least one of the sender or receiver based on a second shared key. The second shared key may be known to both the sender and the receiver. Again, the first shared key may equal the second shared key.

In some embodiments, the first and second knowledge proof may each indicate a sum of the first and second account balances which will not cause a numerical overflow when using computer-based methods.

In some embodiments, the ledger may be further configured for a validation of the transaction by at least one of the sender or the receiver using a method including (1) receiving, over the network, the first and second zero knowledge proofs, the first and second new commitments, first and second previous commitments before the transaction on the elliptical curve, the first and second encrypted account balances, and the encrypted transaction blinding; (2) verifying via the first zero knowledge proof that the first account balance is greater than or equal to zero; (3) verifying via the second zero knowledge proof that the second account balance is greater than or equal to zero; (4) verifying the first and second knowledge proofs indicate a sum of the first and second account balances will not cause a numerical overflow; and (5) verifying a sum of the first and second previous commitments before the transaction on the elliptical curve are equal to a sum of first and second new commitments.

In some embodiments, the ledger may be further configured for revealing the transacted amount to a third party using a method including (1) locating within the ledger an account identifier and a data block identifier associated with the transaction; (2) sending the account identifier and the data block identifier associated with the transaction to the third party; and (3) sending the transaction blinding and the transacted amount to the third party. The third party may then verify that the first and second new commitments correspond to the transaction blinding and the transacted amount; while the first and second account balances are concealed from the third party. In certain embodiments, the third party may provide payment dispute resolution.

The computer-based method may be performed by a server, a personal computer, a workstation, a laptop, a tablet, a smartphone, a smart watch, an Internet-of-Things device or the like. The server may be a hardware server, a virtual server, a virtual container, or the like. The server may form at least a portion of a cloud-computing environment and/or a portion of an enterprise computing environment. In other embodiments, the server is an edge server.

In another embodiment, a computing device includes a memory and at least one processor. The at least one processor is configured to perform a method for recording a transaction in a ledger having a transacted amount, a first account balance associated with a sender and a second account balance associated with a receiver. The method includes (1) encrypting the transacted amount using a first shared key, wherein the first shared key is known to both the sender and the receiver; (2) decreasing the first account balance by the transacted amount; (3) encrypting the first account balance with a first private key, wherein the first private key is known to the sender; (4) increasing the second account balance by the transacted amount; (5) encrypting the second account balance with a second private key, wherein the second private key is known to the receiver; (6) calculating a first next block blinding associated with the first account balance; (7) encrypting the first next block blinding using the first private key; (8) calculating a second next block blinding associated with the second account balance; (9) encrypting the second next block blinding using the second private key; (10) calculating a first new commitment, wherein the first new commitment is a first account new balance representation on an elliptic curve associated with the ledger; (11) calculating a second new commitment, wherein the second new commitment is a second account new balance representation on the elliptic curve associated with the ledger; (12) calculating a first zero knowledge proof indicating the first account balance is greater than or equal to zero; and (13) calculating a second zero knowledge proof indicating the second account balance is greater than or equal to zero. Additionally the ledger is configured for (1) tracking the first account balance and the second account balance within a multi-chain structure, a DAG based structure, or the like; (2) concealing the first account balance and the second account balance; and (3) allowing public verification of the transaction over a network.

In another embodiment, a non-transitory computer-readable storage medium is disclosed. The non-transitory computer-readable storage medium stores computer instructions to be implemented on at least one computing device including at least one processor. The computer instructions when executed by the at least one processor cause the at least one computing device to perform a method for recording a transaction in a ledger having a transacted amount, a first account balance associated with a sender and a second account balance associated with a receiver. The method includes (1) encrypting the transacted amount using a first shared key, wherein the first shared key is known to both the sender and the receiver; (2) decreasing the first account balance by the transacted amount; (3) encrypting the first account balance with a first private key, wherein the first private key is known to the sender; (4) increasing the second account balance by the transacted amount; (5) encrypting the second account balance with a second private key, wherein the second private key is known to the receiver; (6) calculating a first next block blinding associated with the first account balance; (7) encrypting the first next block blinding using the first private key; (8) calculating a second next block blinding associated with the second account balance; (9) encrypting the second next block blinding using the second private key; (10) calculating a first new commitment, wherein the first new commitment is a first account new balance representation on an elliptic curve associated with the ledger; (11) calculating a second new commitment, wherein the second new commitment is a second account new balance representation on the elliptic curve associated with the ledger; (12) calculating a first zero knowledge proof indicating the first account balance is greater than or equal to zero; and (13) calculating a second zero knowledge proof indicating the second account balance is greater than or equal to zero. Additionally the ledger is configured for (1) tracking the first account balance and the second account balance within a multi-chain structure, a DAG based structure, or the like; (2) concealing the first account balance and the second account balance; and (3) allowing public verification of the transaction over a network.

In another embodiment, a computer-based method is disclosed for concealing an account balance with the ability for the network to verify a transaction between any two accounts in a ledger that tracks individual balances in multi-chain or DAG based structures. The computer-based method includes (1) encrypting a transacted amount, by a processor, using a shared (between sender and receiver) key; (2) decreasing a sender's account balance by a transacted amount, by the processor, encrypting sender's new account balance with sender's private key, increasing receiver's account balance by transacted amount and encrypting receiver's new account balance with receiver's private key; (3) generating a transaction blinding, by the processor, by sender, or optionally by receiver, and encrypting it using a shared (between sender and receiver) key; (4) calculating sender's next block blinding, by the processor, and encrypting it with the sender's private key, (5) calculating receiver's next block blinding and encrypting it with receiver's private key; (6) calculating, by the processor, a new sender's commitment which is sender's new balance representation on the elliptic curve, (7) calculating a new receiver's commitment which is receiver's new balance representation on the elliptic curve; and (8) calculating, by the processor, zero knowledge proofs that sender's and receiver's new balances are more or equal than zero, and are not too large in a way that their sum may cause numerical overflow.

In another embodiment, a computer-based method of validating by all network participants a payment transaction between accounts whose balances were concealed using the previously disclosed computer based method in a ledger that tracks individual balances in multi-chain or DAG based structures. The computer-based method includes (1) getting sender's and receiver's transaction data from the network including commitments, zero knowledge proofs, encrypted balances, encrypted blinding values; (2) verifying zero knowledge proofs that sender's and receiver's new balances are more or equal than zero, and are not too large in a way that their sum may cause numerical overflow; and (3) verifying that sum of sender's and receiver's commitment points on the elliptic curve before the transaction equal to the sum of the commitment points after the transaction.

In another embodiment, a computer-based method is disclosed for revealing the transacted amount to the third party to resolve a payment dispute or for another reason without revealing the balance when the balances were concealed using the previously disclosed computer based method in a ledger that tracks individual balances in multi-chain or DAG based structures. The computer-based method includes (1) locating account identifier and data block identifier where transaction happened and sending to the third party; (2) calculating, by the processor, transaction blinding and amount transacted and sending to the third party; and (3) verifying, by the processor, by the third party that sender's and receiver's commitment points correspond to transaction blinding and transacted amount, without knowing the sender's or receiver's balances.

In another embodiment, a Confidential Multi-chain computer-based memory structure in use together with computer-based methods to conceal the balance is disclosed. The Confidential Multi-chain computer-based memory structure includes (1) a memory; (2) a set of chains stored in the memory, wherein each chain represents an individual account and tracks balance changes with privacy; and (3) computer-based methods to conceal the balance;

In another embodiment, a system is disclosed. The system includes a memory, a network interface, an I/O interface, and a processor. The system is configured for communicating with the memory, the network, and I/O interface. The system is configured to perform a method including accessing the memory where sender's or receiver's balance chain is stored. The method further includes generating a transaction when sender submits a command using I/O interface to initiate a payment or receiver sends a command using I/O interface to submit a payment request using the balance concealing method disclosed previously. The method also includes exchanging data between network nodes using a network interface and validating the transaction by all network participants using the validating method disclosed previously.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

The present embodiments are illustrated by way of example and are not intended to be limited by the figures of the accompanying drawings. In the drawings:

FIG. 1 depicts a diagram illustrating a Confidential Multi-Chain structure where each chain represents an individual account and tracks balance changes with privacy in accordance with embodiments of the present disclosure.

FIG. 2 depicts a diagram illustrating formulas (i.e. equations) in accordance with embodiments of the present disclosure.

FIG. 3 depicts a flowchart illustrating details of a transaction flow when a sender initiates a transaction in accordance with embodiments of the present disclosure.

FIG. 4 depicts a flowchart illustrating details of a transaction flow when a receiver initiates transaction in accordance with embodiments of the present disclosure.

FIG. 5 depicts a diagram illustrating a method of revealing a transacted amount to a third party to resolve payment dispute without revealing an account balance in accordance with embodiments of the present disclosure.

FIG. 6 depicts a block diagram illustrating an example of a computing device and/or a computing system configured to conceal the balance, and process and validate a payment transaction in accordance with embodiments of the present disclosure.

### DETAILED DESCRIPTION

The present disclosure relates to cryptocurrencies and payment systems that store individual accounts balances in one or more permissionless distributed ledgers using multi-chain or directed acyclic graph (DAG) based structures. More specifically, methods, systems, and devices are disclosed for solving the technological problem of concealing account balances in multi-chain and DAG based structures, while staying publicly verifiable.

The following description and figures are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The disclosed methods, systems, and devices solve the technological problem of concealing account balances while preserving the ability for the network to verify a transaction between any two accounts in a ledger, wherein the ledger tracks individual balances in multi-chain or DAG based structures.

Details of the data structure and transaction flow are disclosed herein, however, it is to be understood that these are merely examples and specific structural and functional details should not be interpreted as limiting but rather should help to understand the concept and serve as the basis of the claims.

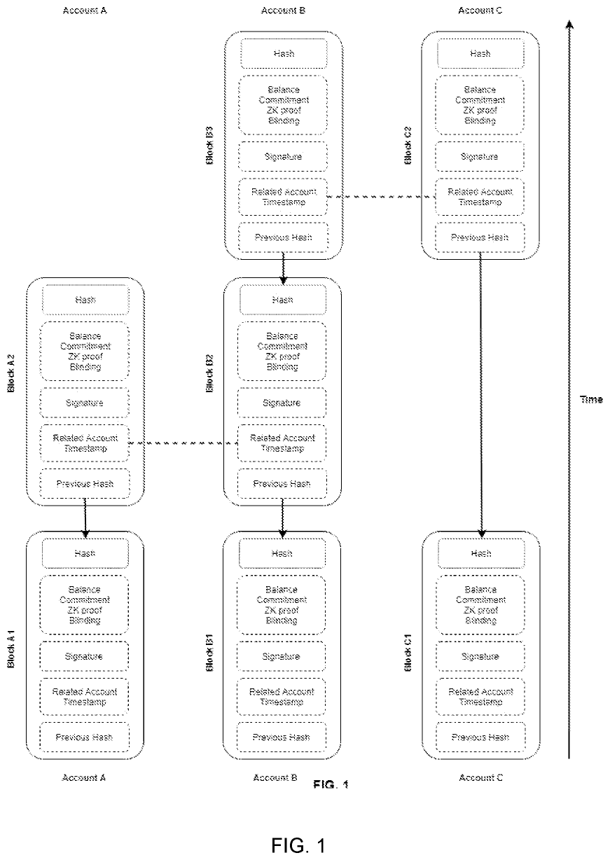

FIG. 1 depicts a diagram illustrating a Confidential Multi-Chain structure, which is one example of multi-chain ledger structure where each chain represents an individual account and tracks balance changes, but with privacy. It shows three accounts each having an individual chain of blocks. The chain has a sequence of blocks that are linked by means of cryptographic hash function like SHA-2: Previous Hash field of the next block contains the Hash of the previous block. Hash is not required to be stored. It can be calculated dynamically based on the content of the block. Each new block contains the updated total account balance, so the chain can be viewed as the history of balances (and maybe other state fields) where the top block has the actual account balance. Each block has a digital signature made by the account holder using a pair of the holder's private and public keys. When a transaction between two accounts happens, the corresponding two chains are linked together, for example by a pair of Related Account and Timestamp fields; this link does not necessarily have a direction but at a minimum means that transaction happened. Many variations of the multi-chain block fields are possible, including, but not limited to: the block may have Height and Related Height fields where Height is the block number in the sequence of blocks and Related Height may be used to refer to the block number in the other chain with which transaction happened, or when two blocks are linked with a random number which is the same number in two blocks so that they can be matched, or Timestamp can be an optional field, etc. The block contains a set of fields for privacy, including, but not limited to: Balance, Blinding, Commitment, Zero-knowledge proof. Balance contains total account balance. Blinding is a number usually generated as a random number or based on multiple random numbers that help building Commitment and/or Zero-knowledge proof. Commitment is a cryptographic primitive that allows one to commit to a chosen value while keeping it hidden to others; examples of commitments are Pedersen Commitment, zk-SNARK commitment, zk-STARK commitment, etc. Zero-knowledge proof is a cryptographic primitive that proves to another party the knowledge of some value without conveying any information apart from the fact that they know the value; examples of zero-knowledge proof protocols are Range Proof, Bulletproof, zk-SNARK, zk-STARK, etc. In one of possible variations of the block structure, the Balance and Blinding fields can be kept only for the head block as these two fields are not part of validation of the previous transactions but are rather needed to construct new block. In FIG. 1 Account A had block A₁, Account B had block B₁, then transaction happened which resulted in construction of new blocks A₂ and B₂ and the link to denote the transaction. FIG. 1 also shows the next transaction between Account B and Account C which resulted in construction of blocks B₃ and C₂ and the link between them. It is to be understood that these details should not be interpreted as limiting and the various forms of multi-chain structures or DAG structures with different fields may exist. The key concept is that the block stores the total account balance and each account (or group of accounts) has a separate chain.

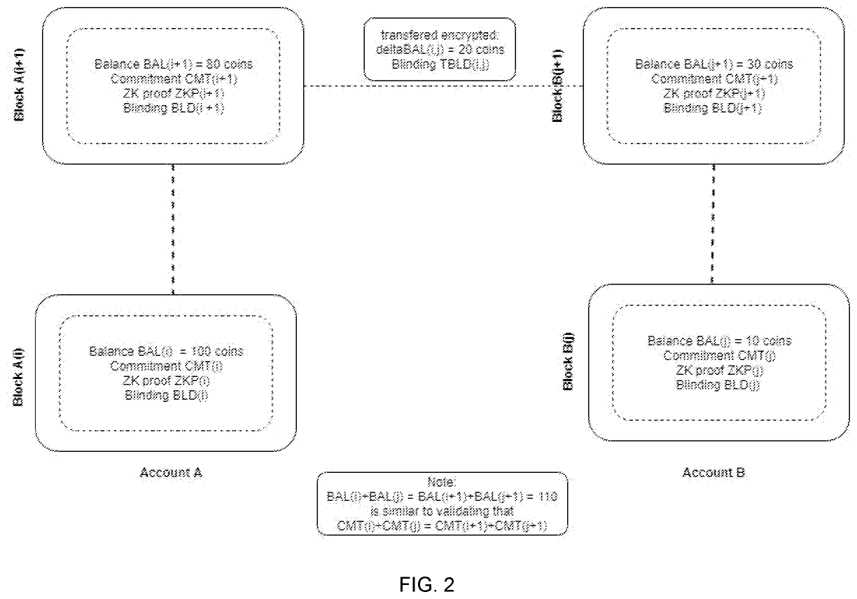

FIG. 2 depicts a diagram illustrating formulas (i.e. equations) and more specifically key elements of the method with abbreviations: balance, commitment, zero-knowledge proof, block blinding, amount transferred, and transaction blinding. Now focusing on one commitment schema—Pedersen Commitment for the purpose of explaining the balance concealing method and use of Confidential Multi-chain structure, however it is to be understood that other commitment schemas and various zero knowledge proof protocols can be used with Confidential Multi-chain structure.

Balance field (BALᵢ) contains total account balance, which is stored cryptographically encrypted, at the time of Blockᵢ—only the owner of account who possesses the private key can decrypt the value. Advanced encryption standard (AES) or any other encryption method may be used to encrypt the field. Balance is always encrypted when transferred thorough the network.

Blinding field (BLDᵢ) is a random number that can be generated like a private key for the elliptic curve. Each block has a unique blinding that is stored encrypted and only known to the account holder. Initially, the first block of the account with zero balance may have blinding equal to zero: BLD₀=0. Blinding is always encrypted when transferred thorough the network.

Transaction Blinding (TBLD_{i,j}) is a random number known only to the pair of sender and receiver participating in a transaction; this blinding does not need to be persisted to the ledger and exists for the duration of transaction. It can be encrypted and decrypted by sender or receiver in using the shared secret known as Elliptic-curve Diffie-Hellman secret as shown in Equations [1] and [2]. Priv_{A} and Pub_{A} represents a pair of private and public keys for Account A.

Secret EC Point_{i,j}=Priv_{A}*Pub_{B}=Priv_{B}*Pub_{A} [1]

Shared Key_{i,j}=X coordinate of Secret EC Point_{i,j} [2]

Blinding of the next block is calculated using the Blinding of the previous block and by adding or subtracting the Transaction Blinding as shown in Equations [3] and [4].

Sender BLDᵢ₊₁=BLDᵢ−TBLD_{i,j} [3]

Receiver BLDⱼ₊₁=BLDⱼ+TBLD_{i,j} [4]

Amount transferred (deltaBAL_{i,j}) is the amount of coins or digital assets transferred from sender to the receiver as part of the transaction. This value does not need to be persisted to the ledger and exists for the duration of transaction. It is encrypted by sender and decrypted by receiver (or vice versa) using the Elliptic-curve Diffie-Hellman shared secret Shared Key_{i,j}. The new balances after the transaction should satisfy Equations [5], [6], and [7].

Sender BALᵢ₊₁=BALᵢ−deltaBAL_{i,j} [5]

Receiver BALⱼ₊₁=BALⱼ+deltaBAL_{i,j} [6]

Sender BALᵢ₊₁+Receiver BALⱼ₊₁=BALᵢ+BALⱼ [7]

Commitment field (CMTᵢ) is a Pedersen Commitment as calculated by Equation [8], where G is the original generator point and H is an additional generator point on the Elliptic Curve such that no one knows the discrete logarithm for H with respect to G. Note, in a variation of the method G and H can be generation points for two different Elliptic Curves.

CMTᵢ=BLDᵢ*H+BALᵢ*G [8]

Since balances are encrypted with the private key known to the account owner only, the network participants do not know account balances. Equations [9], [10], and [11] demonstrate how network participants may use Pedersen commitments to validate that Equation [7] is true.

CMTᵢ₊₁=BLDᵢ₊₁*H+BALᵢ₊₁*G=(BLDᵢ−TBLD_{i,j})*H+(BALᵢ−deltaBAL_{i.j})*G=BLDᵢ*H+BALᵢ*G−TBLD_{i,j}*H−deltaBAL_{i,j}*G=CMTᵢ−TBLD_{i,j}*H−deltaBAL_{i,j}*G [9]

CMTⱼ₊₁=BLDⱼ₊₁*H+BALⱼ₊₁*G=(BLDⱼ+TBLD_{i,j})*H +(BALⱼ+deltaBAL_{i,j})*G=BLDⱼ*H+BALⱼ*G+TBLD_{i,j}*H+deltaBAL_{i,j}*G=CMTⱼ+TBLD_{i,j}*H+deltaBAL_{i,j}*G [10]

CMTᵢ₊₁+CMTⱼ₊₁=CMTᵢ+CMTⱼ [11]

Validating that the sum of balances of two accounts before the transaction equals to the sum of balances after the transaction, as shown in Equation [7], is equivalent to validating that the sum of commitment Elliptic Curve points before the transaction equals to the sum of commitment points after the transaction, as shown in Equation [11], provided that H is selected such that no one knows the discrete logarithm for H with respect to G and that the balance is not a negative number and does not overflow when any two balances are added. The advantage of using commitments is that by knowing the commitment, it is computationally unfeasible to derive the balance.

Zero-knowledge proof (ZKPᵢ) contains a proof that value BALᵢ is in the range of [0, N], where N is a large number (e.g., 2⁶⁴) without revealing the value. Without zero-knowledge proof an attacker could send more coins than he has leaving his total balance negative in one wallet and creating new coins in the second wallet while commitments would still add up. One of the popular zero-knowledge proof protocols that may used is called Bulletproof which is calculated and verified based on BALᵢ, BLDᵢ and CMTᵢ

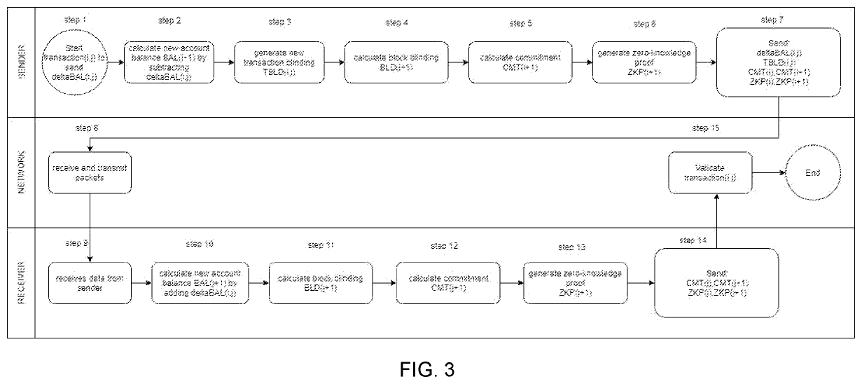

FIG. 3 depicts a flowchart describing steps of a method and a system for the case when a sender initiates transaction.

In Step 1, the Sender with head block Blockᵢ initiates transaction to send deltaBAL_{i,j}, coins (or other digital assets) to the Receiver with head block Blockⱼ·deltaBAL_{i,j} is encrypted using Shared Key_{i,j} in Equation [2].

In Step 2, a Sender's new balance is calculated using Equation [5] and encrypted with sender's private key.

In Step 3, transaction blinding is generated as a large random number TBLD_{i,j} and encrypted using Shared Key_{i,j} in Equation [2]. Note that the variation of the step can be when receiver generates transaction blinding and sends it encrypted to the sender via network.

In Step 4, a Sender's next block blinding is calculated with Equation [3] and encrypted with sender's private key.

In Step 5, a Sender's commitment is calculated with Equations [9] or [8].

In Step 6, a Sender's zero-knowledge proof ZKPᵢ₊₁ is calculated using zero-knowledge proof protocol, for example Bulletproof (BALᵢ₊₁, BLDᵢ₊₁, CMTᵢ₊₁).

In Step 7, data is sent to the network: deltaBAL_{i,j}, TBLD_{i,j}, CMTᵢ₊₁, CMTᵢ, ZKPᵢ₊, ZKPᵢ. Additional data may be sent as well, like sender/receiver public key address, block hashes, signatures, BLDᵢ₊₁, BLDᵢ, BALᵢ₊₁, BALᵢ, etc. Also previous block data could be sent before, and is included to explain the concept.

In Step 8, the network is receiving and transmitting packets.

Step 9, the Receiver gets data from the network and identifies that the transaction is sent for him Receiver can decrypt deltaBAL_{i,j} and TBLD_{i,j} using Shared Key_{i,j} in Equation [2].

In Step 10, a Receiver's new balance is calculated using Equation [6] and encrypted with receiver's private key.

Step 11, a Receiver's next block blinding is calculated with Equation [4] and encrypted with receiver's private key.

In Step 12, a Receiver's commitment is calculated with Equation [10] or [8].

Step 13, a Receiver's zero-knowledge proof ZKPⱼ₊₁ is calculated using zero-knowledge proof protocol, for example Bulletproof (BAL_{J+1}, BLDⱼ₊₁ , CMTⱼ₊₁).

Step 14, data is sent to the network: CMT_{J+1}, CMTⱼ, ZKPⱼ₊₁, ZKP_{J}. Additional data may be sent as well, like sender/receiver public key address, block hashes, signatures, BLDⱼ₊₁, BLDⱼ, BALⱼ₊₁, BALⱼ, etc. Also previous block data may be sent before, and are included to explain the concept.

In Step 15, when sender and receiver blocks are matched, all network participants can validate the transaction using Equation [11] and verifying ZKPᵢ₊₁ and ZKPⱼ₊₁ using zero-knowledge proof protocol, for example Bulletproof (ZKPᵢ₊₁, CMTᵢ₊₁), Bulletproof (ZKPⱼ₊₁, CMTⱼ₊₁).

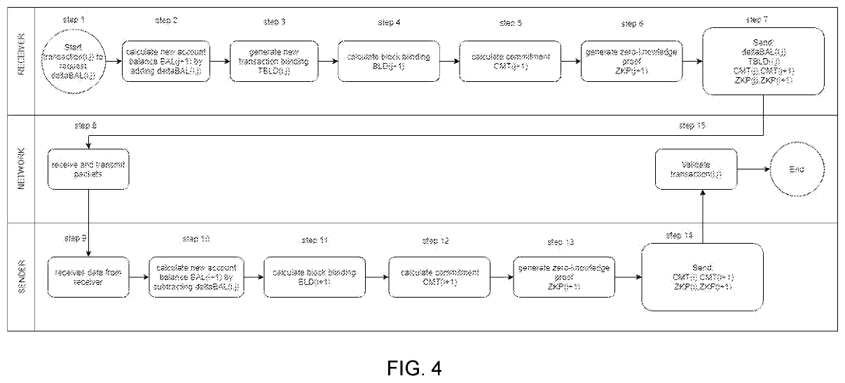

FIG. 4 depicts a flowchart describing steps for a method and a system for a case when a receiver requests payment. The flowchart of FIG. 4 is similar to the flowchart in FIG. 3, however the order of activities is different.

In Step 1, a Receiver with head block Blockⱼ initiates transaction by requesting a payment of deltaBAL_{i,j} coins from the Sender with head block Blockᵢ. deltaBAL_{i,j} is encrypted using Shared Key_{i,j} in Equation [2].

In Step, a Receiver's new balance is calculated using Equation [6] and encrypted with receiver's private key.

In Step 3, transaction blinding is generated as a large random number TBLD_{i,j} and encrypted using Shared Key_{i,j} in Equation [2]. Note that the variation of the step may be when sender generates transaction blinding and sends it encrypted to the receiver via network.

In Step 4, Receiver's next block blinding is calculated with Equation [4] and encrypted with receiver's private key.

In Step 5, Receiver's commitment is calculated with Equation [10] or [8].

In Step 6: Receiver's zero-knowledge proof ZKPⱼ₊₁ is calculated using zero-knowledge proof protocol, for example Bulletproof (BALⱼ₊₁, BLDⱼ₊₁, CMTⱼ₊₁).

In Step 7: data is sent to the network: deltaBAL_{i,j}, TBLD_{i,j}, CMTⱼ₊₁, CMTⱼ, ZKPⱼ₊₁, ZKPⱼ. Additional data may be sent as well, such as sender/receiver public key address, block hashes, signatures, BLDⱼ₊₁, BLDⱼ, BALⱼ₊₁, BALⱼ, etc. Also previous block data may be sent before, and are included to explain the concept.

In Step 8, the network is receiving and transmitting packets.

In Step 9, the Sender gets data from the network and identifies that the payment request transaction is sent for him Sender can decrypt deltaBAL_{i,j} and TBLD_{i,j} using Shared Key_{i,j} in Equation [2].

In Step 10, Sender's new balance is calculated using Equation [5] and encrypted with sender's private key.

In Step 11, Sender's next block blinding is calculated with Equation [3] and encrypted with sender's private key.

In Step 12, Sender's commitment is calculated with Equation [9] or [8].

In Step 13, Sender's zero-knowledge proof ZKPᵢ₊₁ is calculated using zero-knowledge proof protocol, for example Bulletproof (BALᵢ₊₁, BLDᵢ₊₁, CMTᵢ₊₁).

Step 14: Data is sent to the network: CMTᵢ₊₁, CMTᵢ, ZKPᵢ₊₁, ZKPᵢ. Additional data may be sent as well, like sender/receiver public key address, block hashes, signatures, BLDᵢ₊₁, BLDᵢ, BALᵢ₊₁, BALᵢ, etc. Also previous block data may be sent before, and is included to explain the concept.

In Step 15, when sender and receiver blocks are matched, all network participants can validate the transaction using Equation [11] and verifying ZKPᵢ₊₁ and ZKPⱼ₊₁ using zero-knowledge proof protocol, for example Bulletproof (ZKPᵢ₊₁, CMTᵢ₊₁), Bulletproof (ZKPⱼ₊₁, CMTⱼ₊₁).

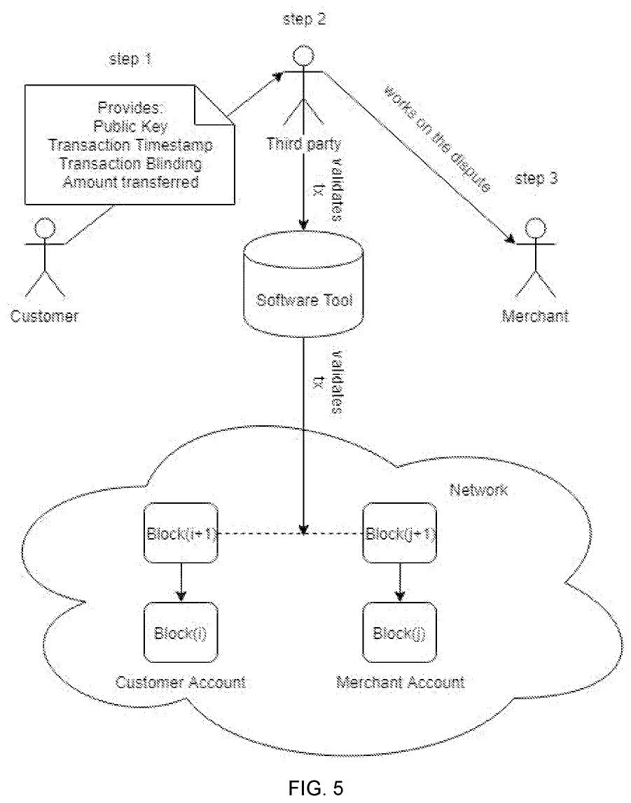

FIG. 5 depicts a diagram illustrating a method of how the details of the transaction can be revealed to the third party in a way that it cannot know the balances of accounts between which transaction took place but the transacted amount can be verified. This is helpful especially in commercial domains, for example, when the customer wants to dispute the transaction after purchasing the goods and not receiving them from the merchant. This is related to cryptocurrencies and/or payment systems which use the encryption methods and concepts shown in FIG. 1 through FIG. 4.

In Step 1, if the customer wants to initiate a transaction dispute, the following data should be provided to the third party:
1) Identifier of the customer account and of the block generated as part of the transaction. This could be a pair of Public Key and Timestamp. Public Key identifies the customer chain and Timestamp in that chain uniquely identifies the block in the chain. The block contains a link to the block of the merchant account to whom the digital assets were sent (as shown in FIG. 1, this is a pair of Related Account and Timestamp). So the Public Key and Timestamp will be sufficient to locate Blockᵢ, Blockᵢ₊₁, Blockⱼ₊₁ in the distributed ledger.
2) TBLD_{i,j} which can be calculated using Equation [3]. Since TBLD_{i,j} is not permanently stored in the ledger, it should be calculated with Equation [12]. To do this, the owner of the account needs to decrypt BLDᵢ and BLDᵢ₊₁ from Blockᵢ and Blockᵢ₊₁ and apply Equation [12].

TBLD_{i,j}=Sender BLDᵢ−Sender BLDᵢ₊₁ [12]

If the receiver (the merchant) is initiating the dispute, TBLD_{i,j} is calculated using Equation [4] as further shown in Equation [13].

TBLD_{i,j}=Receiver BLDⱼ₊₁−Receiver BLDⱼ [13]
3) Amount transferred deltaBAL_{i,j} which may be calculated using Equation [5] as further shown in Equation [14].

deltaBAL_{i,j}=Sender BALᵢ−Sender BALᵢ₊₁ [14]

This will require the owner of the account to decrypt the balance of two blocks and provide the delta to the third party. If the dispute is initiated by the receiver, then Equation [6] can be used as further shown in Equation [15].

deltaBAL_{i,j}=Receiver BALⱼ₊₁−Receiver BALⱼ [15]

In Step 2, the third party validates using the data submitted that this transaction really took place and amount is correct. It can use the software tool that implements the Equation below and run it against identified blocks in the distributed ledger; Equation [9] can be used as further shown in Equation [16].

CMTᵢ₊₁=CMTᵢ−TBLD_{i,j}*H−deltaBAL_{i,j}*G [16]

Since CMT is available in the ledger, G and H are commonly known generation points on the Elliptic Curve, TBLD_{i,j} and deltaBAL_{i,j} are provided by the account holder, then Equation [16] can be verified. If the account holder provides incorrect transacted amount deltaBAL_{i,j}, then the account holder would also need to provide TBLD_{i,j}, which is equal to, using Equation [16] as further shown in Equation [17].

TBLD_{i,j}*H=CMTᵢ−CMTᵢ₊₁−deltaBAL_{i,j}*G=Y [17]

Since it is computationally infeasible to calculate discrete logarithm of point Y with respect to H and discrete logarithm of H with respect G is also unknown, TBLD_{i,j} cannot be calculated for a given deltaBAL_{i,j} so that Equation (16) is true. If the receiver initiates the dispute, then the Equation [10] can be used as further shown in Equation [18].

TBLD_{i,j}*H=CMTⱼ₊₁−CMTⱼ−deltaBAL_{i,j}*G [18]

It is important to note that to provide TBLD_{i,j} and deltaBAL_{i,j} one should know the account private key to decrypt the fields in Equations [12] and [14] which proves the ownership of the account. Also the method demonstrated that the balances of any of the two accounts were not revealed.

In Step 3, once the third party validated through the ledger that the transacted amount is correct, it can work with the merchant on the dispute. Since Equation [11] is true and validated by all network participants, then the merchant won't be able to provide a different pair of TBLD_{i,j} and deltaBAL_{i,j} to claim that the transacted amount is different.

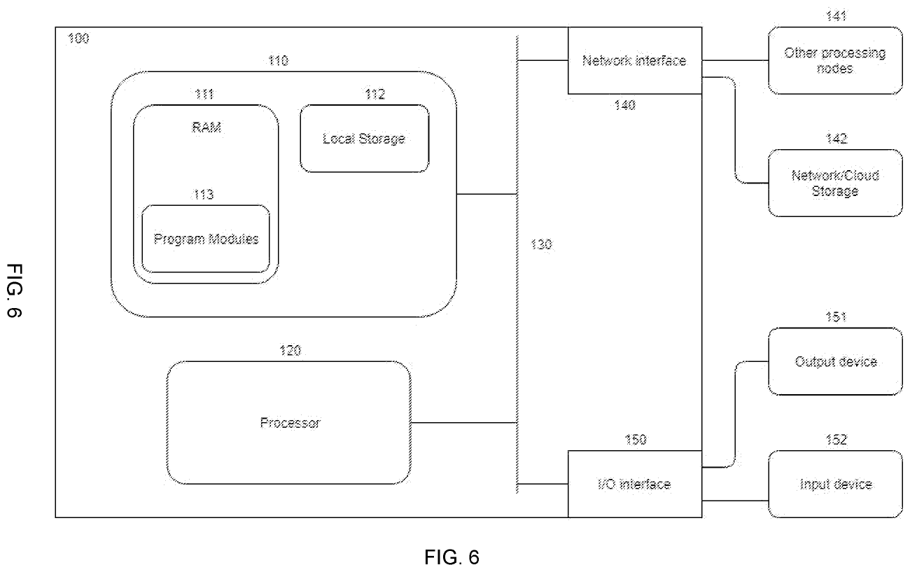

FIG. 6 depicts a block diagram illustrating an example of a computing device and/or computing system to implement the subject matter disclosed herein, including concealing the balance, processing, validating, disputing a payment transaction. The computing device and/or the computing system includes computing hardware device 100, which has a processor 120, memory 110, network interface 140, I/O interface 150 and a bus 130 which connects these parts.

The memory 110 may include random access memory (RAM) 111 or any other type of volatile memory, local disk storage 112 including hard disk drive, SSD or any other type of non-volatile memory. Program modules 113 are loaded into RAM which may include Operating System, program data and program executable instructions.

The processor 120 together with the memory 110 implements the data structures and methods described in FIG. 1 through FIG. 5. The described above executable instructions and data are loaded from the local storage 112 into RAM memory 111 and processed by the processor 120. The computer system has I/O interface 150 to read user input from Input device 152 including, but not limited to, keyboard or mouse pointing device, and to display the result on Output device 151 including, but not limited to, monitor or printer.

Network interface 140 is used by the system to communicate with other processing nodes 141 that can participate in transactions or observe and validate them or with network storage devices 142. The bus 130 links memory 110, processor 120, network interface 140 and I/O interface 150. The bus 130 represents one or more bus structures, including but not limited to, memory bus, local bus, peripheral bus, etc.

It should be understood that the methods defined in the claims and above can be implemented entirely as a hardware component, for example as a specialized circuits, entirely as a software component or a combination of both. It is to be understood that FIG. 6 illustrates one possible implementation and other variations are possible which may include any combination of any hardware components, thus the example should not be considered as limiting.

In conclusion, this disclosure describes the methods, devices, and systems to cryptographically conceal the account balance with the ability for the network to verify a transaction between any two accounts in a ledger, wherein the ledger tracks individual balances in multi-chain or DAG based structures. Basically these methods, devices, and systems provide a technological solution to conceal the balance while staying publicly verifiable. Such a technological solution is important for wide adoption of a cryptocurrency or payment system where network participants cannot see each other's balance, especially a balance of merchant accounts. At the same time there should be a method of revealing transacted amount to the third party for a payment dispute without revealing the account balances. Introduced herein is a Confidential Multi-chain structure used to implement such a technological solution. As disclosed the methods, devices, and systems generate the private transaction, pass it through the network and allow validation by any network participant, including the case when the receiver is initiating the transaction by submitting a payment request. The methods, devices, and systems demonstrate how the transacted amount may be revealed to the third party to resolve a payment dispute without revealing the balance. Also, disclosed herein are methods that may be be implemented entirely as a hardware component, for example as a specialized circuit(s), entirely as a software component (e.g. a non-transitory computer-readable storage medium) storing computer instructions, or a combination of both.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, SAS, Tensorflow, CUDA, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create an ability for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The disclosure has been presented for purposes of illustration and description, but is not intended to be exhaustive or limited in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method for recording a transaction in a ledger having a transacted amount, a first account balance associated with a sender and a second account balance associated with a receiver; the computer-based method comprising:
encrypting the transacted amount using a first shared key, wherein the first shared key is known to both the sender and the receiver;
decreasing the first account balance by the transacted amount;
encrypting the first account balance with a first private key, wherein the first private key is known to the sender;
increasing the second account balance by the transacted amount;
encrypting the second account balance with a second private key, wherein the second private key is known to the receiver calculating a first next block blinding associated with the first account balance;
encrypting the first next block blinding using the first private key;
calculating a second next block blinding associated with the second account balance;
encrypting the second next block blinding using the second private key;
calculating a first new commitment, wherein the first new commitment is a first account new balance representation on an elliptic curve associated with the ledger;
calculating a second new commitment, wherein the second new commitment is a second account new balance representation on the elliptic curve associated with the ledger;
calculating a first zero knowledge proof indicating the first account balance is greater than or equal to zero;
and
calculating a second zero knowledge proof indicating the second account balance is greater than or equal to zero, wherein the ledger is configured for:
tracking the first account balance and the second account balance in at least one of a multi-chain structure or a directed acyclic graph (DAG) based structure;
concealing the first account balance and the second account balance;
and
allowing public verification of the transaction over a network.

2. The computer-based method of claim 1 further comprising:
generating a transaction blinding; and
encrypting the transaction blinding using a second shared key, wherein the second shared key is known to both the sender and the receiver.

3. The computer-based method of claim 2, wherein the first shared key equals the second shared key.

4. The computer-based method of claim 2, wherein the first and second knowledge proofs each indicate a sum of the first and second account balances will not cause a numerical overflow.

5. The computer-based method of claim 4, wherein the ledger is further configured for a validation of the transaction by at least one of the sender or the receiver using a method comprising:
receiving, over the network, the first and second zero knowledge proofs, the first and second new commitments, first and second previous commitments before the transaction on the elliptical curve, the first and second encrypted account balances, and the encrypted transaction blinding;
verifying via the first zero knowledge proof that the first account balance is greater than or equal to zero;
verifying via the second zero knowledge proof that the second account balance is greater than or equal to zero;
verifying the first and second knowledge proofs indicate a sum of the first and second account balances will not cause a numerical overflow; and
verifying a sum of the first and second previous commitments before the transaction on the elliptical curve are equal to a sum of first and second new commitments.

6. The computer-based method of claim 4, wherein the ledger is further configured for revealing the transacted amount to a third party using a method comprising:
locating within the ledger an account identifier and a data block identifier associated with the transaction;
sending the account identifier and the data block identifier associated with the transaction to the third party; and
sending the transaction blinding and the transacted amount to the third party, wherein:
the third party verifies that the first and second new commitments correspond to the transaction blinding and the transacted amount; and
the first and second account balances are concealed from the third party.

7. The computer-based method of claim 6, wherein the third party provides payment dispute resolution.

8. The computer-based method of claim 1 further comprising receiving an encrypted transaction blinding, wherein:
the encrypted transaction blinding was generated by a least one of the sender or receiver based on a second shared key; and
the second shared key is known to both the sender and the receiver.

9. The computer-based method of claim 8, wherein the first shared key equals the second shared key.

10. A computing device comprising:
a memory; and
at least one processor configured to perform a method for recording a transaction in a ledger having a transacted amount, a first account balance associated with a sender and a second account balance associated with a receiver; the method comprising:
encrypting the transacted amount using a first shared key, wherein the first shared key is known to both the sender and the receiver;
decreasing the first account balance by the transacted amount;
encrypting the first account balance with a first private key, wherein the first private key is known to the sender;
increasing the second account balance by the transacted amount;
encrypting the second account balance with a second private key, wherein the second private key is known to the receiver
calculating a first next block blinding associated with the first account balance;
encrypting the first next block blinding using the first private key;
calculating a second next block blinding associated with the second account balance;
encrypting the second next block blinding using the second private key;
calculating a first new commitment, wherein the first new commitment is a first account new balance representation on an elliptic curve associated with the ledger;
calculating a second new commitment, wherein the second new commitment is a second account new balance representation on the elliptic curve associated with the ledger;
calculating a first zero knowledge proof indicating the first account balance is greater than or equal to zero;
and
calculating a second zero knowledge proof indicating the second account balance is greater than or equal to zero, wherein the ledger is configured for:
tracking the first account balance and the second account balance in at least one of a multi-chain structure or a directed acyclic graph (DAG) based structure;
concealing the first account balance and the second account balance;
and
allowing public verification of the transaction over a network.

11. A non-transitory computer-readable storage medium, the non-transitory computer-readable storage medium storing computer instructions to be implemented on at least one computing device including at least one processor, the computer instructions when executed by the at least one processor cause the at least one computing device to perform a method for recording a transaction in a ledger having a transacted amount, a first account balance associated with a sender and a second account balance associated with a receiver; the method comprising:
encrypting the transacted amount using a first shared key, wherein the first shared key is known to both the sender and the receiver;
decreasing the first account balance by the transacted amount;
encrypting the first account balance with a first private key, wherein the first private key is known to the sender;
increasing the second account balance by the transacted amount;
encrypting the second account balance with a second private key, wherein the second private key is known to the receiver
calculating a first next block blinding associated with the first account balance;
encrypting the first next block blinding using the first private key;
calculating a second next block blinding associated with the second account balance;
encrypting the second next block blinding using the second private key;
calculating a first new commitment, wherein the first new commitment is a first account new balance representation on an elliptic curve associated with the ledger;
calculating a second new commitment, wherein the second new commitment is a second account new balance representation on the elliptic curve associated with the ledger;
calculating a first zero knowledge proof indicating the first account balance is greater than or equal to zero;
and
calculating a second zero knowledge proof indicating the second account balance is greater than or equal to zero, wherein the ledger is configured for:
tracking the first account balance and the second account balance in at least one of a multi-chain structure or a directed acyclic graph (DAG) based structure;
concealing the first account balance and the second account balance;
and
allowing public verification of the transaction over a network.
